(19) United States
(12) Patent Application Publication
(10) Pub. No.: US 2025/0208939 A1
(43) Pub. Date: Jun. 26, 2025

(54) METHODS AND APPARATUS TO MONITOR CORRECTABLE ERRORS FOR A DEVICE INTERFACE

(71) Applicant: Intel Corporation, Santa Clara, CA (US)

(72) Inventors: Tao Xu, Shanghai (CN); Changpeng Guo, Suzhou (CN); Shijie Liu, Shanghai (CN); Yufu Li, Portland, OR (US)

(73) Assignee: Intel Corporation, Santa Clara, CA (US)

(21) Appl. No.: 19/076,713

(22) Filed: Mar. 11, 2025

(30) Foreign Application Priority Data
Apr. 15, 2024 (WO) PCT/CN2024/087672

(51) Int. Cl. G06F 11/07

(52) U.S. Cl. CPC G06F 11/076; G06F 11/0721; G06F 11/0757; G06F 2201/81

(57) ABSTRACT

Disclosed examples include interface circuitry; machine-readable instructions; and at least one out-of-band processor circuit to be coupled to at least one host processor circuit, the at least one out-of-band processor circuit to be programmed by the machine-readable instructions to at least: detect a first error in a link between devices; increment an error count after the detection of the first error; decrement the error count after a duration has elapsed relative to the first error; and cause sending of a message to a reliability, accessibility, and serviceability agent after the error count satisfies a threshold.

### RELATED APPLICATION

This patent claims the benefit of PCT Patent Application No. PCT/CN2024/087672, which was filed on Apr. 15, 2024. PCT Patent Application No. PCT/CN2024/087672 is hereby incorporated herein by reference in its entirety. Priority to PCT Patent Application No. PCT/CN2024/087672 is hereby claimed.

### BACKGROUND

Data centers are used to house installations of large numbers of resources including server resources, storage resources, and network hardware resources. Such resources are configured to work cooperatively to store data, process data, and exchange data with outside entities. Keeping such data available, secure, and error free is part of managing the resources in the data centers.

### BRIEF DESCRIPTION OF THE DRAWINGS

FIG. 1 is a dataflow diagram of a prior implementation for Device Interconnect (DI) Link Agent (DILA) correctable error reporting.

FIG. 2 is a block diagram of an example implementation of an apparatus that may be used to implement DILA correctable error reporting.

FIG. 3 is a flow diagram that may be used to implement the apparatus of FIG. 2 to perform DILA correctable error reporting.

FIG. 4 is a flowchart representative of example machine-readable instructions and/or example operations that may be executed, instantiated, and/or performed by example programmable circuitry to implement the apparatus of FIG. 2 to perform DILA correctable error reporting.

FIG. 5 is a block diagram of an example processing platform including programmable circuitry structured to execute, instantiate, and/or perform the example machine-readable instructions and/or perform the example operations of FIGS. 3 and 4 to implement examples of this disclosure.

FIG. 6 is a block diagram of an example implementation of the programmable circuitry of FIG. 5.

FIG. 7 is a block diagram of another example implementation of the programmable circuitry of FIG. 5.

FIG. 8 is a block diagram of an example software/firmware/instructions distribution platform (e.g., one or more servers) to distribute software, instructions, and/or firmware (e.g., corresponding to the example machine-readable instructions of FIGS. 3 and 4) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Examples disclosed herein may be used to implement correctable error (CE) counters and leaky buckets for device interconnect link agent (DILA) links. Examples disclosed herein use an out-of-band processor (e.g., a memory microcontroller (MMC)) to monitor and calculate error count and rate to implement a software device interconnect (DI) leaky bucket. In examples disclosed herein, software DI leaky buckets execute in a hardware layer outside of a host operating system (OS). This operation is different from host-based software leaky buckets of prior solutions that run in host OS's. Examples disclosed herein decrease the impacts on system performance that can be created by host-based software leaky buckets.

In examples disclosed herein, a device interconnect (DI) is a combined cache-coherent, input-output (IO) and memory access protocol which enables high bandwidth connection between die-to-die (D2D), central processing unit (CPU) to CPU, CPU to memory hubs, and/or CPU to IO Agents. In some examples, a DI may employ an Intel® Ultra-Path Interconnect (Intel® UPI) and Compute Express Link™ (CXL™) interface. Additionally or alternatively, in some examples, a DI may employ a Universal Chiplet Interconnect Express (UCIe) standard to implement a high-bandwidth, low-latency connection between computing blocks inside a chip. In other examples, a DI may be implemented using any other interface standard.

There are multiple factors that could cause DI link correctable errors such as breaks in physical pins, electrical noise, electrical margin, high-energy particle strikes, etc. In examples disclosed herein, DILA is a device that detects and reports DI link correctable errors.

Due to the correctable nature of a correctable error, platform software does not need to respond to each reported corrected error. A DILA is configurable to report every corrected error. For example, if signaling via System Management Interrupt (SMI) is configured, then every corrected error would trigger an SMI. In some examples, customers do not need to keep track of every corrected error. Additionally, if there is a marginal link, then excessive corrected errors would be detected resulting in an SMI-storm. Therefore, in some examples, customers disable SMI for such corrected errors. However, the platform can still keep track of these correctable errors as an indicator of the health of the DI link.

Examples disclosed herein provide a software solution to implement a threshold-based, error-rate-monitored correctable error reporting mechanism for DI links. For example, an MMC sends an error message to an RAS agent when a software threshold is reached. Examples disclosed herein include a software error counter mechanism for error threshold and a software leaky bucket mechanism for error rate monitoring. The software error counter, error rate, and leaky bucket are implemented in an out-of-band processor (e.g., an MMC). Using an out-of-band processor removes performance impacts relative to implementing the software error counter/rate and leaky bucket in a host processor. While an example software solution is disclosed herein, examples disclosed herein may alternatively be implemented exclusively in hardware or as a combination of hardware and software.

In examples disclosed herein, a suitable leaky bucket timer timeout value and error threshold can be configured according to specific characteristics or aspects of different hardware designs. In this way, examples disclosed herein signal DI correctable errors at specific threshold error rates (e.g., threshold or maximum error notification rates) of corresponding error monitoring implementations. In examples disclosed herein, a threshold error rate is a configurable rate at which detected correctable errors are reported to a basic input-output system (BIOS). As such, an error rate may also be referred to as an error notification rate or a rate of error reporting because the error rate controls how often the BIOS is notified of detected correctable errors. A threshold (or maximum) error rate is configurable based on values selected for the leaky bucket timer timeout value and the error threshold. By reporting correctable errors according to such threshold error rates, examples disclosed herein can be used to predict persistent errors without significant system performance degradation that could otherwise result from more frequent system interruptions based on higher rates of error reporting.

The software error counter, soft error rate, and software leaky bucket examples disclosed herein can provide a more accurate DI link correctable error report mechanism, avoid performance degradations due to DI link correctable error burst and provide a way to measure the frequency of DI link-level correctable errors for profiling the integrity of a link to predict a system crisis before it happens.

Examples disclosed herein report DI link correctable errors more precisely than prior solutions. Examples disclosed herein substantially decrease or eliminate performance degradation due to DI link correctable error bursts. Examples disclosed herein provide a way to measure the frequency of DI link-level correctable errors to profile the integrity of a link. Examples disclosed herein can be used to predict a system crisis before it occurs. Examples disclosed herein may be used to implement a correctable error counter and threshold-based error reporting mechanism. Examples disclosed herein may be used to implement correctable error rate logic and predict uncorrectable errors based on software correctable error rates. Examples disclosed herein may be used to implement correctable error rate-based link recovery and a link speed degradation feature. In examples disclosed herein, a link speed degradation feature can be used as a mitigation strategy to reduce DI link errors by decreasing the speed of the DI link and/or changing configuration parameters associated with the DI link.

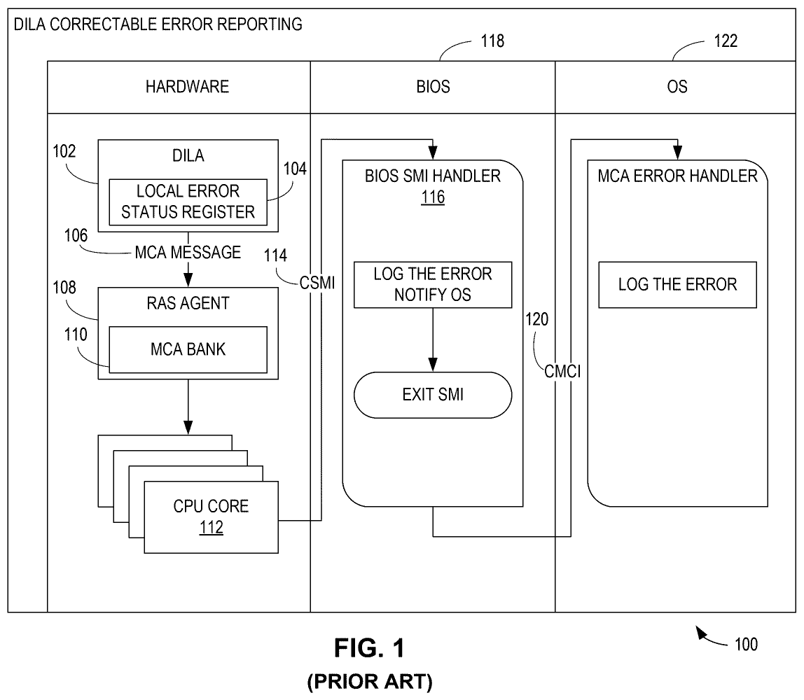

FIG. 1 is a dataflow diagram 100 of a prior implementation for DILA correctable error reporting. In FIG. 1, after a correctable error is detected by a DILA 102, the DILA 102 logs the error in its local error status registers 104 and sends a Machine Check Architecture (MCA) Message 106 to a RAS Agent 108 through a sideband interface. The RAS Agent 108 logs the content of the MCA Message 106 in an MCA Bank 110 (also known as Model Specific Registers (MSRs)) and broadcasts this event to CPU cores 112. If SMI is configured as the type of interrupt to use for DILA correctable error reporting, the CPU cores 112 generate a Correctable machine check interrupt SMI (CSMI) 114. In a BIOS SMI handler 116, a BIOS 118 probes the error, logs the error, and signals a Correctable Machine Check Interrupt (CMCI) 120 to notify an operating system (OS) 122. The OS 122 accesses the log and shows it in its event log list. This process happens for each DI link correctable error.

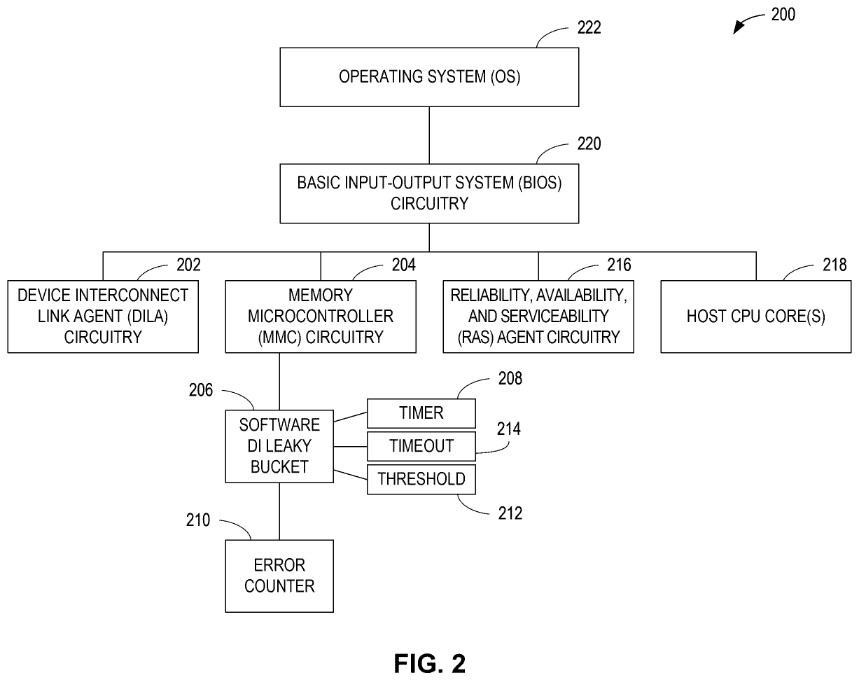

Prior implementations of DILA correctable error reporting have no hardware logic to count the DI link correctable error or hardware logic to calculate correctable error rate. When SMI is chosen to signal an error in prior implementations, a persistent correctable error can continuously trigger SMI and lead to decreased system performance. Unlike prior solutions, examples disclosed herein enable end users to configure a DILA correctable error reporting system to not report a correctable error for every occurrence and instead to report errors at a specified error rate (e.g., a threshold error notification rate). Examples disclosed herein enable end users to select whether to disable correctable error reporting and signal if a correctable error is known as a persistent error. As described below in connection with FIG. 2, examples disclosed herein provide an error counter and correctable error rate calculation support to control (e.g., configure) the rate of correctable error reporting.

Prior implementations of DILA correctable error reporting do not measure the frequency of link-level correctable errors to profile the integrity of a link and predict non-fatal and fatal errors. Unlike such prior implementations, the configurable rate of error reporting provided by examples disclosed herein may be used to implement a predictive error reporting mechanism so that an OS can defensively work to prevent system damages and data loss.

FIG. 2 is a block diagram of an example implementation of an apparatus 200 that may be used to implement DILA correctable error reporting. The apparatus 200 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the apparatus 200 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The apparatus 200 includes example device interconnect link agent (DILA) circuitry 202, example memory microcontroller (MMC) circuitry 204, example reliability, availability, and serviceability (RAS) agent circuitry 216, one or more example host CPU core(s) 218, example basic input-output system (BIOS) circuitry 220, and an example operating system (OS) 222. In the example of FIG. 2, the MMC circuitry 204 includes an example software DI leaky bucket 206, and the software DI leaky bucket 206 includes an example timer 208, an example error counter 210, an example error count threshold 212, and an example timeout value 214.

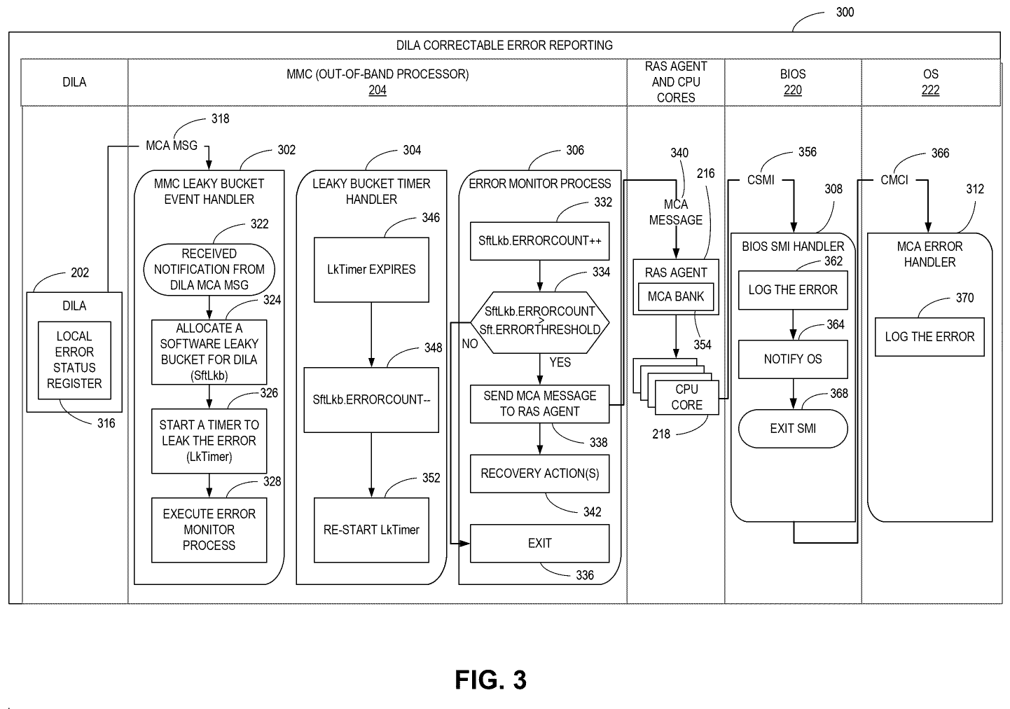

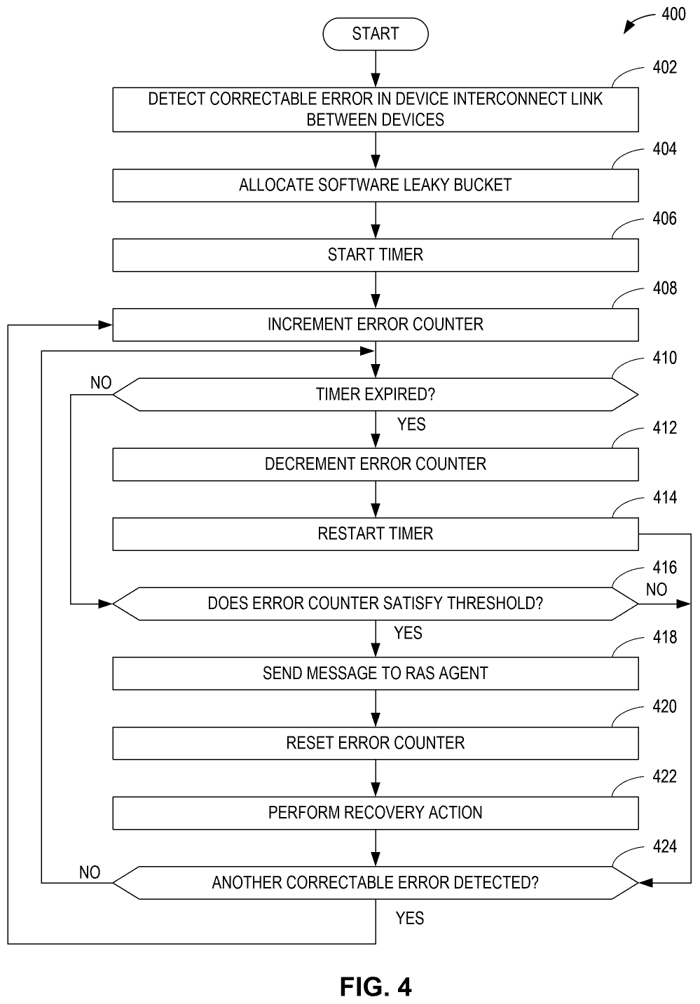

The DILA circuitry 202 is provided to monitor communications on a DI link between two devices or between two components. Based on such monitoring, the DILA circuitry 202 detects when DI link correctable errors occur on the DI link. For example, the DILA circuitry 202 monitors communications on a DI link and uses one or more error-detection methods to determine when a communication includes an error. For example, the DILA circuitry 202 may use parity check error detection, cyclic redundancy check (CRC) error detection, and/or any other suitable type of error detection to detect errors on DI links. The DILA circuitry 202 notifies the MMC circuitry 204 when it detects a DI link correctable error on a monitored DI link. The DI link is a connection (e.g., a high bandwidth connection) between two components such as a die-to-die (D2D) connection, a CPU-to-CPU connection, a CPU-to-memory hub(s) connection, a CPU-to-IO agent(s) connection, and/or a connection between any other types of components. In some examples, the DILA circuitry 202 is instantiated by programmable circuitry executing DILA instructions and/or configured to perform operations such as those represented by the flowcharts of FIGS. 3 and 4.

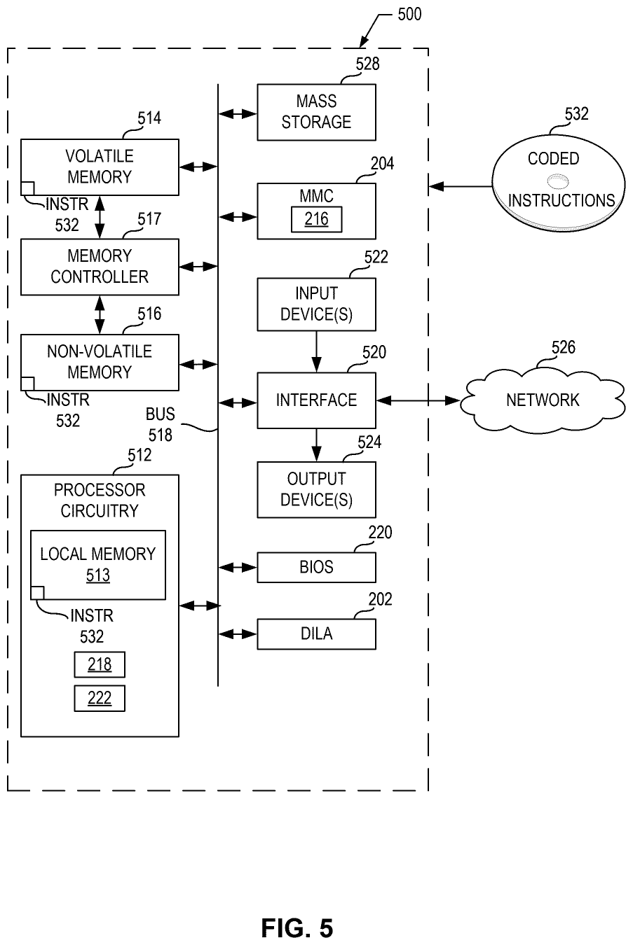

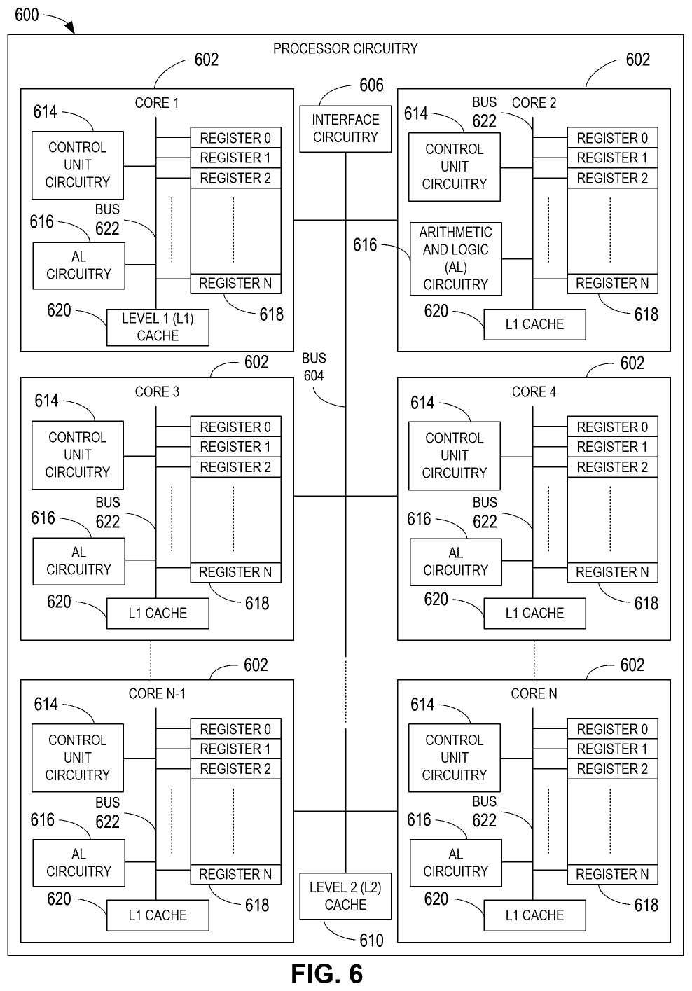

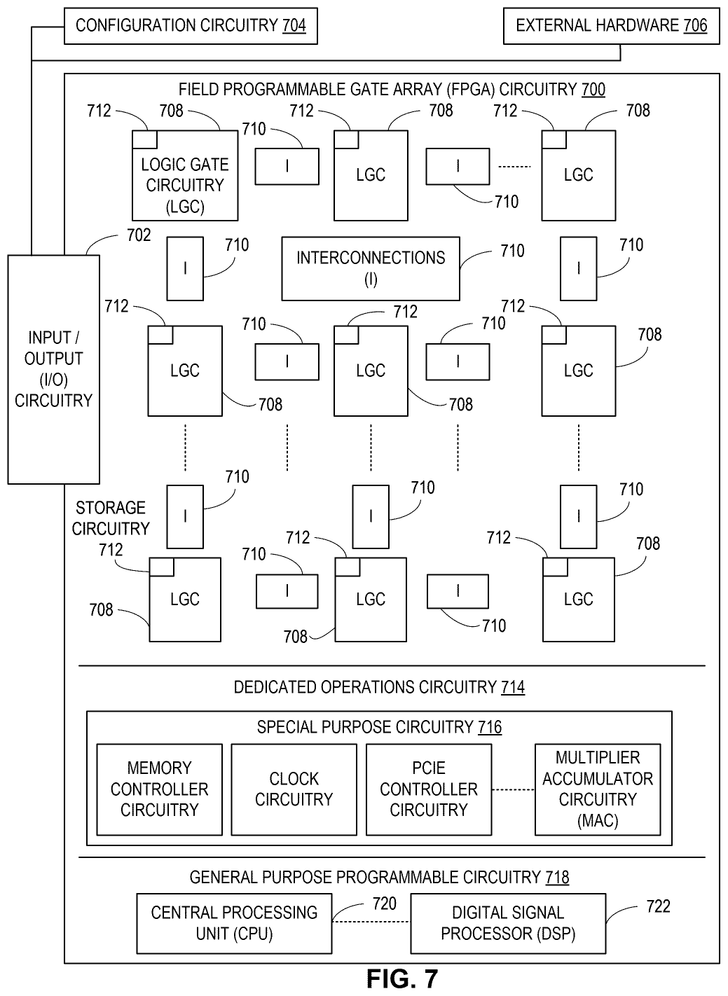

In some examples, the apparatus 200 includes means for detecting correctable errors in a link between devices. For example, the means for detecting correctable errors may be implemented by the DILA circuitry 202. In some examples, the DILA circuitry 202 may be instantiated by programmable circuitry such as the example programmable circuitry 512 of FIG. 5. For instance, the DILA circuitry 202 may be instantiated by the example microprocessor 600 of FIG. 6 executing machine-executable instructions such as those implemented by at least block 402 of FIG. 4. In some examples, the DILA circuitry 202 may be instantiated by hardware logic circuitry, which may be implemented by an ASIC, XPU, or the FPGA circuitry 700 of FIG. 7 configured and/or structured to perform operations corresponding to the machine-readable instructions. Additionally or alternatively, the DILA circuitry 202 may be instantiated by any other combination of hardware, software, and/or firmware. For example, the DILA circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The MMC circuitry 204 is a controller that is provided in the apparatus 200 in addition to a memory controller (e.g., the memory controller 517 of FIG. 5) and which is used as a memory training agent and memory correctable error aggregator. The MMC circuitry 204 is a sideband interface device that is connected into sideband fabric. As such, any device that is connected into the sideband fabric can communicate with the MMC circuitry 204. In examples disclosed herein, the DILA circuitry 202 is one such device that communicates with the MMC circuitry 204 via the sideband fabric.

In examples disclosed herein, the MMC circuitry 204 is an out-of-band processor and includes interface circuitry to communicate with the DILA circuitry 202, the RAS agent circuitry 216, the host CPU core(s) 218, and the BIOS circuitry 220. As used herein, an out-of-band processor is programmable circuitry (e.g., a processor, a controller, etc.) that is separate from a host processor (e.g., the host CPU core(s) 218) of an apparatus. By providing an out-of-band processor, the out-of-band processor can handle low-level or back-end tasks/processes (e.g., correctable error monitoring disclosed herein). Accordingly, resources of the host processor are freed up to execute user-facing applications, programs, services, etc. without incurring resource congestion by the low-level or back-end tasks/processes. Although examples disclosed herein are described in association with the MMC circuitry 204, such disclosed examples may alternatively be implemented by any other type of out-of-band processor.

The MMC circuitry 204 is provided to monitor and calculate error count and error rate as part of the software DI leaky bucket 206. In examples disclosed herein, the software DI leaky bucket 206 runs in a hardware layer outside of the OS 222. For example, the MMC circuitry 204 is programmed by machine-readable instructions that cause the MMC circuitry 204 to instantiate and run the software DI leaky bucket 206 at the hardware layer. The MMC circuitry 204 instantiates the timer 208, the error counter 210, the error count threshold 212, and the timeout value 214 as part of the software DI leaky bucket 206. For example, the software DI leaky bucket 206 can be a software object and the timer 208, the error counter 210, the error count threshold 212, and the timeout value 214 can be properties of that software object. As used herein, a software object is a computer-programmable entity defined in object-oriented programming that has defined data (e.g., properties, attributes, etc.) and methods. Although examples disclosed herein are described in connection with using the error counter 210 to track error count values, in other examples, error count values may be tracked using a hardware register or a memory location. For example, a hardware register or a memory location may be used to store error count values and to increment and/or decrement the error count values as described below. In yet other examples, the error counter 210 may be implemented using a hardware register or a memory location.

To implement the software DI leaky bucket 206, the MMC circuitry 204 can define suitable values for the timeout value 214 (e.g., a leaky bucket timer timeout value) and the error count threshold 212 based on aspects of a hardware design. Examples of such hardware design aspects include link speed, link width, link length, desired link stability, link interface circuit design (e.g., transceiver design), environment of the link (e.g., temperature, noise, etc.), etc. The software DI leaky bucket 206 can use the timeout value 214 and/or the error count threshold 212 to signal DI link correctable errors at a particular threshold error rate (e.g., a threshold or maximum error notification rate). That is, the timeout value 214 and/or the error count threshold 212 configure (e.g., limit) how often DI correctable errors detected by the DILA circuitry 202 are reported to the BIOS circuitry 220 and/or the OS 222. As such, system interruptions of the apparatus 200 due to DI correctable errors are limited to an interruption frequency that does not exceed the threshold error rate established by the timeout value 214 and/or the error count threshold 212. By limiting error signaling to such an error rate, a persistent error can be predicted (e.g., detected) and system performance impacts on the apparatus 200 can be mitigated without decreasing system performance. For example, techniques disclosed herein can increase system performance by substantially reducing or eliminating excessive system interruptions of the apparatus 200. Such excessive system interruptions are reduced or eliminated by waiting to notify the BIOS circuitry 220 of DI correctable errors that are detected at a higher frequency than the error rate defined by the timeout value 214 and/or the error count threshold 212 of examples disclosed herein.

In examples disclosed herein, each time a DI correctable error is detected, the error counter 210 of the software DI leaky bucket 206 is incremented by one. When the count value of the error counter 210 satisfies (e.g., is equal to or greater than) the error count threshold 212, the MMC circuitry 204 notifies the RAS agent circuitry 216, and the RAS agent circuitry 216 sends an interrupt to the BIOS circuitry 220. As such, instead of notifying the RAS agent circuitry 216 and interrupting the BIOS circuitry 220 for every detected DI correctable error, such notifications and interruptions are sent only after a threshold number of DI correctable errors have been detected. This decreases system interruptions of the OS 222 significantly to an error rate controlled by the error count threshold 212.

The error rate is further controllable through selection of the timeout value 214. In examples disclosed herein, the timeout value 214 is used to initialize the timer 208 to countdown to zero (or to count up to the timeout value 214). When the timer 208 times out based on the timeout value 214, an error count value of the error counter 210 is decremented by one. Accordingly, if DI correctable errors are detected less often than the duration of the timeout value 214, the timeout value 214 causes the count value in the error counter 210 to remain below the error count threshold 212 for a longer duration. This, in turn, decreases system interruptions of the OS 222 significantly to an error rate controlled by the combination of the timeout value 214 and the error count threshold 212.

Through use of the software DI leaky bucket 206, examples disclosed herein can be used to configure error rates so that DI correctable errors are reported to the BIOS circuitry 220 sufficiently often to prevent accumulations of correctable errors that could otherwise cause uncorrectable errors. The software DI leaky bucket 206 can also be used to detect high rates of correctable errors as predictive indicators of imminent uncorrectable errors. As such, the software DI leaky bucket 206 can be used to monitor and/or adjust correctable error rate to implement system fault forecasting.

In some examples, the apparatus 200 includes means for handling error monitoring. For example, the means for handling error monitoring may be implemented by the MMC circuitry 204. In some examples, the MMC circuitry 204 may be instantiated by programmable circuitry such as the example programmable circuitry 512 of FIG. 5. For instance, the MMC circuitry 204 may be instantiated by the example microprocessor 600 of FIG. 6 executing machine-executable instructions such as those implemented by at least blocks 322, 324, 326, 328, 332, 334, 336, 338, 346, 348, and 352 of FIG. 3 and/or blocks 404, 408, 410, 412, 414, 416, 418, 420, 422, and 424 of FIG. 4. In some examples, the MMC circuitry 204 may be instantiated by hardware logic circuitry, which may be implemented by an ASIC, XPU, or the FPGA circuitry 700 of FIG. 7 configured and/or structured to perform operations corresponding to the machine-readable instructions. Additionally or alternatively, the MMC circuitry 204 may be instantiated by any other combination of hardware, software, and/or firmware. For example, the MMC circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The RAS agent circuitry 216 is provided to maintain reliability, availability, and serviceability of the apparatus 200 at a particular level by notifying the BIOS circuitry 220 of correctable error occurrences that satisfy the error count threshold 212. For example, the apparatus 200 may be a server that is leased by a customer or that runs a service leased by a customer. In such an example, the customer may specify a particular level of reliability, availability, and serviceability expected of the leased server and/or service. The RAS agent circuitry 216 is configured to maintain that customer-specified level of reliability, availability, and serviceability by making the BIOS circuitry 220 aware of ongoing correctable errors on a DI link. As such, through the RAS agent circuitry 216, higher up times and lower down times can be maintained for a server and/or service that could be affected by DILA correctable error reporting. To maintain different levels of service, the RAS agent circuitry 216 includes RAS features such as correctable error detection and reporting. In some examples, the RAS agent circuitry 216 is instantiated by programmable circuitry executing RAS instructions and/or configured to perform operations such as those represented by the flowcharts of FIGS. 3 and 4.

In some examples, the apparatus 200 includes means for notifying a BIOS of correctable errors. For example, the means for notifying the BIOS of correctable errors may be implemented by the RAS agent circuitry 216. In some examples, the RAS agent circuitry 216 may be instantiated by programmable circuitry such as the example programmable circuitry 512 of FIG. 5. For instance, the RAS agent circuitry 216 may be instantiated by the example microprocessor 600 of FIG. 6 executing machine-executable instructions to implement the RAS agent circuitry 216 as described in connection with FIGS. 2 and 3. In some examples, the RAS agent circuitry 216 may be instantiated by hardware logic circuitry, which may be implemented by an ASIC, XPU, or the FPGA circuitry 700 of FIG. 7 configured and/or structured to perform operations corresponding to the machine-readable instructions. Additionally or alternatively, the RAS agent circuitry 216 may be instantiated by any other combination of hardware, software, and/or firmware. For example, the RAS agent circuitry 216 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The host CPU core(s) 218 execute(s) machine-readable instructions to run applications, programs, services, etc. on the apparatus 200. For example, the host CPU core(s) 218 execute(s) machine-readable instructions to run the OS 222.

In some examples, the apparatus 200 includes means for executing machine-executable instructions. For example, the means for executing machine-executable instructions may be implemented by the host CPU core(s) 218. In some examples, the host CPU core(s) 218 may be instantiated by programmable circuitry such as the example programmable circuitry 512 of FIG. 5. For instance, the host CPU core(s) 218 may be instantiated by the example microprocessor 600 of FIG. 6 to execute machine-executable instructions to run applications, programs, services, the OS 222, etc. In some examples, the host CPU core(s) 218 may be instantiated by hardware logic circuitry, which may be implemented by an ASIC, XPU, or the FPGA circuitry 700 of FIG. 7 configured and/or structured to perform operations corresponding to the machine-readable instructions. Additionally or alternatively, the host CPU core(s) 218 may be instantiated by any other combination of hardware. For example, the host CPU core(s) 218 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The BIOS circuitry 220 controls input and output operations of hardware circuitry. For example, the BIOS circuitry 220 enables the OS 222 to interface with hardware of the apparatus 200 so that the OS 222 can access data, devices, services, etc. at the hardware level.

In some examples, the apparatus 200 includes means for controlling input and output operations of hardware circuitry. For example, the means for controlling input and output operations of hardware circuitry may be implemented by the BIOS circuitry 220. In some examples, the BIOS circuitry 220 may be instantiated by programmable circuitry to execute machine-executable instructions to run hardware-level firmware. In some examples, the BIOS circuitry 220 may be instantiated by hardware logic circuitry, which may be implemented by an ASIC, XPU, or the FPGA circuitry 700 of FIG. 7 configured and/or structured to perform operations corresponding to the machine-readable instructions. Additionally or alternatively, the BIOS circuitry 220 may be instantiated by any other combination of hardware. For example, the BIOS circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The OS 222 may be any suitable OS including, for example, a Microsoft® Windows® OS, a Mac OS® operating system, a Unix OS, a Linux OS, etc. In some examples, the apparatus 200 may include means for handling correctable errors at a user level in a computing environment. Such means for handling correctable errors at a user level may be implemented by the OS 222.

While an example manner of implementing the apparatus 200 of FIG. 2, one or more of the elements, processes, and/or devices illustrated in FIG. 2 may be combined, divided, re-arranged, omitted, eliminated, and/or implemented in any other way. Further, the example DILA circuitry 202, the example MMC circuitry 204, the example RAS agent circuitry 216, the example host CPU core(s) 218, the example BIOS circuitry 220, the example OS 222, and/or, more generally the example apparatus 200 of FIG. 2, may be implemented by hardware alone or by hardware in combination with software and/or firmware. Thus, for example, any of the example DILA circuitry 202, the example MMC circuitry 204, the example RAS agent circuitry 216, the example host CPU core(s) 218, the example BIOS circuitry 220, the example OS 222, and/or, more generally the example apparatus 200, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example apparatus 200 of FIG. 2 may include one or more elements, processes, and/or devices in addition to, or instead of, those illustrated in FIG. 2, and/or may include more than one of any or all of the illustrated elements, processes and devices.

Flowcharts representative of example machine-readable instructions, which may be executed by programmable circuitry to implement and/or instantiate the apparatus 200 of FIG. 2 and/or representative of example operations which may be performed by programmable circuitry to implement and/or instantiate the apparatus 200 of FIG. 2, are shown in FIGS. 3 and 4. The machine-readable instructions may be one or more executable programs or portion(s) of one or more executable programs for execution by programmable circuitry such as the programmable circuitry 512 shown in the example processor platform 500 discussed below in connection with FIG. 5 and/or may be one or more function(s) or portion(s) of functions to be performed by the example programmable circuitry (e.g., an FPGA) discussed below in connection with FIGS. 6 and/or 7. In some examples, the machine-readable instructions cause an operation, a task, etc., to be carried out and/or performed in an automated manner in the real world. As used herein, “automated” means without human involvement.

The program(s) may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program(s) is/are described with reference to the flowcharts illustrated in FIGS. 3 and 4, many other methods of implementing the example apparatus 200 may alternatively be used. For example, the order of execution of the blocks of the flowcharts may be changed, and/or some of the blocks described may be changed, eliminated, or combined. Additionally or alternatively, any or all of the blocks of the flowcharts may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine-executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine-executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 3 and 4 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 3 is an example flow diagram 300 that may be used to implement the apparatus 200 of FIG. 2 to perform DILA correctable error reporting. The flow diagram 300 of FIG. 3 includes the DILA circuitry 202, the MMC circuitry 204, the RAS agent circuitry 216, the host CPU core(s) 218, the BIOS circuitry 220, and the OS 222. In the example of FIG. 3, the MMC circuitry 204 implements an example MMC leaky bucket event handler 302, an example leaky bucket timer handler 304, and an example error monitor process 306. Also in the example of FIG. 3, the BIOS circuitry 220 implements an example BIOS SMI handler 308, and the OS implements an example MCA error handler 312. Operations of the example MMC leaky bucket event handler 302, the example leaky bucket timer handler 304, the example error monitor process 306, the example BIOS SMI handler 308, and the MCA error handler 312 may be executed, instantiated, and/or performed by machine-executable instructions executed by corresponding ones of the MMC circuitry 204, the BIOS circuitry 220, and the OS 222.

In the example of FIG. 3, after the DILA circuitry 202 detects a correctable error on a DI link, the DILA circuitry 202 stores or updates a status of an example local error status register 316 to reflect the occurrence of the detected correctable error. The DILA circuitry 202 sends an example MCA message 318 to the MMC circuitry 204. In response to receipt of the notification via the MCA message 318 from the DILA circuitry 202 (block 322), the MMC circuitry 204 executes the MMC leaky bucket event handler 302. As part of the MMC leaky bucket event handler 302, the MMC circuitry 204 allocates a software leaky bucket (SoftLkb) (e.g., the software DI leaky bucket 206 of FIG. 2) (block 324). If it is the first detected correctable error for that particular DI link, the MMC circuitry 204 starts a leaky bucket timer (softLkb.LkTimer) (e.g., the timer 208 of FIG. 2) (block 326). For example, the MMC circuitry 204 resets the timer 208 to zero and starts the timer 208 to count up to the timeout value 214. Alternatively, the MMC circuitry 204 sets the timer 208 to the timeout value 214 and starts the timer 208 to count down to zero. In any case, the duration of the timer 208 is configured to expire based on the timeout value 214. Also, as part of the MMC leaky bucket event handler 302, the MMC circuitry 204 executes the error monitor process 306 (block 328). In the example of FIG. 3, every time the MMC circuitry 204 receives an MCA message 318 from the DILA circuitry 202, the MMC leaky bucket event handler 302 causes the MMC circuitry 204 to execute the error monitor process 306.

During execution of the error monitor process 306, the MMC circuitry 204 increments the error counter 210 of FIG. 2 (e.g., SoftLkb.ErrorCount) by one (block 332). The MMC circuitry 204 compares the error count value of the error counter 210 to the error count threshold 212 of FIG. 2 (e.g., SoftLkb.ErrorThreshold) (block 334). If the MMC circuitry 204 determines that the error count value of the error counter 210 does not satisfy (e.g., is not greater than) the error count threshold 212 (block 334: NO), the error monitor process 306 exits (block 336). However, if the MMC circuitry 204 determines that the error count value of the error counter 210 satisfies (e.g., is greater than) the error count threshold 212 (block 334: YES), control advances to block 338 at which the MMC circuitry 204 sends an example MCA message 340 to the RAS agent circuitry 216. For example, the MMC circuitry 204 sends the MCA message 340 through a sideband interface (e.g., a sideband fabric). The MCA message 340 notifies the RAS agent circuitry 216 of the accumulated correctable error occurrences tracked by the error counter 210.

Also, as part of the error monitor process 306, the MMC circuitry 204 performs one or more recovery action(s) (block 342). For example, the MMC circuitry 204 performs one or more recovery actions to mitigate DI link error occurrences. In some examples, recovery actions include decreasing a speed of the DI link, adjusting one or more configuration parameters of the DI link, and/or any other suitable actions. In some examples, recovery actions implementable by the MMC circuitry 204 are based on the type of DI link. For example, recovery actions for a DI link based on the Peripheral Component Interconnect Express (PCIe) standard can be specified in a PCIe specification. In such examples, the MMC circuitry 204 uses PCIe-specific link retraining recovery actions to decrease the occurrences of errors on the DI link.

The MMC circuitry 204 also executes the leaky bucket timer handler 304 to monitor the timer 208. As part of the leaky bucket timer handler 304, the MMC circuitry 204 determines when the timer 208 expires (block 346). After expiration of the timer 208 (block 346), the MMC circuitry 204 decrements the error counter 210 (e.g., SoftLkb.ErrorCount) by one (block 348). In addition, the MMC circuitry 204 restarts the timer 208 (block 352).

After the error counter 210 satisfies the error count threshold 212, the RAS agent circuitry 216 receives the MCA message 340 and logs the content of the MCA message 340 in an example MCA bank 354 (e.g., a Model Specific Register (MSR)). The RAS agent circuitry 216 broadcasts the error event to the host CPU core(s) 218. The host CPU core(s) 218 send(s) an example Correctable machine check interrupt SMI (CSMI) 356 to the BIOS circuitry 220 to notify the BIOS circuitry 220 of the error event (e.g., the error counter 210 satisfying the error count threshold 212). In the BIOS SMI handler 308, the BIOS circuitry 220 logs the error event (bock 362) and notifies the OS 222 (block 364) by creating and sending an example Correctable Machine Check Interrupt (CMCI) 366 to the OS 222. The CMCI 366 notifies the OS 222 of the error event. The BIOS circuitry 220 exits the BIOS SMI handler 308 (block 368). The OS 222 logs the error event in its event log list (block 370). In some examples, the OS 222 displays a notification or other text and/or graphical representation of the error event and/or the event log list on a display of the apparatus 200.

FIG. 4 is a flowchart representative of example machine-readable instructions and/or example operations 400 that may be executed, instantiated, and/or performed by example programmable circuitry to implement the apparatus 200 of FIG. 2 to perform DILA correctable error reporting. The instructions and/or operations 400 begin at block 402 at which the DILA circuitry 202 detects a correctable error in a DI link between devices. In some examples, block 402 is implemented by the MMC circuitry 204 at which the MMC circuitry 204 detects the correctable error based on a message (e.g., the MCA message 318) from the DILA circuitry 202.

At block 404, the MMC circuitry 204 allocates the software DI leaky bucket 206. For example, the MMC circuitry 204 allocates the software DI leaky bucket 206 for a particular DI link in response to a notification (e.g., the MCA message 318) from the DILA circuitry 202 corresponding to the detection of the correctable error. As described above, the software DI leaky bucket 206 is instantiated as an object that includes the error counter 210, the timer 208, the timeout value 214, and the error count threshold 212 as properties.

At block 406, the MMC circuitry 204 starts the timer 208. For example, the MMC circuitry 204 starts the timer 208 based on the timeout value 214 to implement a threshold (or maximum) error notification rate. The MMC circuitry 204 uses the timer 208 to track a duration that has elapsed since the correctable error detected at block 402.

At block 408, the MMC circuitry 204 increments the error counter 210. For example, the MMC circuitry 204 increments an error count value of the error counter 210 in response to the detection of the correctable error detected at block 402. At block 410, the MMC circuitry 204 determines whether the timer 208 has expired. Expiration of the timer 208 indicates that the tracked duration (e.g., a duration equal to the timeout value 214) relative to the detection of the correctable error at block 402 has elapsed. If the timer 208 has not expired (block 410: NO), control advances to block 416. When the timer 208 expires (block 410: YES), control advances to block 412 at which the MMC circuitry 204 decrements the error counter 210. That is, the MMC circuitry 204 decrements the error count value of the error counter 210 after the timer 208 expires. At block 414, the MMC circuitry 204 restarts the timer 208. For example, the MMC circuitry 204 restarts the timer 208 after the error counter 210 is decremented at block 412.

At block 416, the MMC circuitry 204 determines whether the error counter 210 satisfies the error count threshold 212. For example, the MMC circuitry 204 compares the error count value of the error counter 210 to a value of the error count threshold 212 to determine whether the error count value of the error counter 210 is greater than the error count threshold 212. If the error counter 210 does not satisfy the error count threshold 212 (block 416: NO), control advances to block 424. Otherwise, if the error counter 210 satisfies the error count threshold 212 (block 416: YES), control advances to block 418 at which the MMC circuitry 204 sends a message to the RAS agent circuitry 216. For example, the MMC circuitry 204 sends the MCA message 340 to the RAS agent circuitry 216 to notify the RAS agent circuitry 216 of an error event which corresponds to the detected correctable errors tracked by the error counter 210. In some examples, the RAS agent circuitry 216 may process the MCA message 340 as described above in connection with FIG. 3. In addition, the host CPU core(s) 218, the BIOS circuitry 220, and the OS 222 may also implement corresponding operations, as described above in connection with FIG. 3, after the RAS agent circuitry 216 receives the MCA message 340.

At block 420, the MMC circuitry 204 resets the error counter 210. At block 422, the MMC circuitry 204 performs one or more recovery actions. For example, the MMC circuitry 204 may perform one or more recovery actions as described above in connection with block 342 of FIG. 3. At block 424, the MMC circuitry 204 determines whether the DILA circuitry 202 has detected another correctable error. If the DILA circuitry 202 has not detected another correctable error (block 424: NO), control returns to block 410. If the DILA circuitry 202 has detected another correctable error (block 424: YES), control returns to block 408. The instructions and/or operations 400 of FIG. 4 may end in response to a DI link being disconnected, in response to a power down event, and/or in response to one or more other events that render the error monitoring no longer necessary or desired.

FIG. 5 is a block diagram of an example programmable circuitry platform 500 structured to execute and/or instantiate the example machine-readable instructions and/or the example operations of FIGS. 3 and 4 to implement the apparatus 200 of FIG. 2. The programmable circuitry platform 500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 500 includes the DILA circuitry 202, the MMC circuitry 204, and the BIOS circuitry 220 in communication with an example bus 518. In the illustrated example, the MMC circuitry 204 implements the RAS agent circuitry 216. In other examples, the RAS agent circuitry 216 may be implemented in the BIOS circuitry 220, in a host CPU that includes the host CPU core(s) 218, or in circuitry separate from the MMC circuitry 204, the BIOS circuitry 220, and a host CPU that includes the host CPU core(s) 218.

The programmable circuitry platform 500 of the illustrated example includes programmable circuitry 512. The programmable circuitry 512 of the illustrated example is hardware. For example, the programmable circuitry 512 can be implemented by one or more integrated circuits, logic circuits, FPGAs, microprocessors, CPUs, GPUs, VPUs, DSPs, and/or microcontrollers from any desired family or manufacturer. The programmable circuitry 512 may be implemented by one or more semiconductor based (e.g., silicon based) devices. In this example, the programmable circuitry 512 implements the host CPU core(s) 218 and the OS 222.

The programmable circuitry 512 of the illustrated example includes a local memory 513 (e.g., a cache, registers, etc.). The programmable circuitry 512 of the illustrated example is in communication with main memory 514, 516, which includes a volatile memory 514 and a non-volatile memory 516, by the bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517. In some examples, the memory controller 517 may be implemented by one or more integrated circuits, logic circuits, microcontrollers from any desired family or manufacturer, or any other type of circuitry to manage the flow of data going to and from the main memory 514, 516.

The programmable circuitry platform 500 of the illustrated example also includes interface circuitry 520. The interface circuitry 520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user (e.g., a human user, a machine user, etc.) to enter data and/or commands into the programmable circuitry 512. The input device(s) 522 can be implemented by, for example, an audio sensor, a microphone, a camera (still or video), a keyboard, a button, a mouse, a touchscreen, a trackpad, a trackball, an isopoint device, and/or a voice recognition system.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 500 of the illustrated example also includes one or more mass storage discs or devices 528 to store firmware, software, and/or data. Examples of such mass storage discs or devices 528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 532, which may be implemented by the machine-readable instructions of FIGS. 3 and 4, may be stored in the mass storage device 528, in the volatile memory 514, in the non-volatile memory 516, and/or on at least one non-transitory computer-readable storage medium such as a CD or DVD which may be removable.

FIG. 6 is a block diagram of an example implementation of the programmable circuitry 512 of FIG. 5. In this example, the programmable circuitry 512 of FIG. 5 is implemented by a microprocessor 600. For example, the microprocessor 600 may be a general-purpose microprocessor (e.g., general-purpose microprocessor circuitry). The microprocessor 600 executes some or all of the machine-readable instructions of the flowcharts of FIGS. 3 and 4 to effectively instantiate the circuitry of FIG. 2 as logic circuits to perform operations corresponding to those machine-readable instructions. In some such examples, the circuitry of FIG. 2 is instantiated by the hardware circuits of the microprocessor 600 in combination with the machine-readable instructions. For example, the microprocessor 600 may be implemented by multi-core hardware circuitry such as a CPU, a DSP, a GPU, an XPU, etc. Although it may include any number of example cores 602 (e.g., 1 core), the microprocessor 600 of this example is a multi-core semiconductor device including N cores. The cores 602 of the microprocessor 600 may operate independently or may cooperate to execute machine-readable instructions. For example, machine code corresponding to a firmware program, an embedded software program, or a software program may be executed by one of the cores 602 or may be executed by multiple ones of the cores 602 at the same or different times. In some examples, the machine code corresponding to the firmware program, the embedded software program, or the software program is split into threads and executed in parallel by two or more of the cores 602. The software program may correspond to a portion or all of the machine-readable instructions and/or operations represented by the flowcharts of FIGS. 3 and 4.

The cores 602 may communicate by a first example bus 604. In some examples, the first bus 604 may be implemented by a communication bus to effectuate communication associated with one(s) of the cores 602. For example, the first bus 604 may be implemented by at least one of an Inter-Integrated Circuit (I2C) bus, a Serial Peripheral Interface (SPI) bus, a PCI bus, or a PCIe bus. Additionally or alternatively, the first bus 604 may be implemented by any other type of computing or electrical bus. The cores 602 may obtain data, instructions, and/or signals from one or more external devices by example interface circuitry 606. The cores 602 may output data, instructions, and/or signals to the one or more external devices by the interface circuitry 606. Although the cores 602 of this example include example local memory 620 (e.g., Level 1 (L1) cache that may be split into an L1 data cache and an L1 instruction cache), the microprocessor 600 also includes example shared memory 610 that may be shared by the cores (e.g., Level 2 (L2 cache)) for high-speed access to data and/or instructions. Data and/or instructions may be transferred (e.g., shared) by writing to and/or reading from the shared memory 610. The local memory 620 of each of the cores 602 and the shared memory 610 may be part of a hierarchy of storage devices including multiple levels of cache memory and the main memory (e.g., the main memory 514, 516 of FIG. 5). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 602 may be referred to as a CPU, DSP, GPU, etc., or any other type of hardware circuitry. Each core 602 includes control unit circuitry 614, arithmetic and logic (AL) circuitry (sometimes referred to as an ALU) 616, a plurality of registers 618, the local memory 620, and a second example bus 622. Other structures may be present. For example, each core 602 may include vector unit circuitry, single instruction multiple data (SIMD) unit circuitry, load/store unit (LSU) circuitry, branch/jump unit circuitry, floating-point unit (FPU) circuitry, etc. The control unit circuitry 614 includes semiconductor-based circuits structured to control (e.g., coordinate) data movement within the corresponding core 602. The AL circuitry 616 includes semiconductor-based circuits structured to perform one or more mathematic and/or logic operations on the data within the corresponding core 602. The AL circuitry 616 of some examples performs integer based operations. In other examples, the AL circuitry 616 also performs floating-point operations. In yet other examples, the AL circuitry 616 may include first AL circuitry that performs integer-based operations and second AL circuitry that performs floating-point operations. In some examples, the AL circuitry 616 may be referred to as an Arithmetic Logic Unit (ALU).

The registers 618 are semiconductor-based structures to store data and/or instructions such as results of one or more of the operations performed by the AL circuitry 616 of the corresponding core 602. For example, the registers 618 may include vector register(s), SIMD register(s), general-purpose register(s), flag register(s), segment register(s), machine-specific register(s), instruction pointer register(s), control register(s), debug register(s), memory management register(s), machine check register(s), etc. The registers 618 may be arranged in a bank as shown in FIG. 6. Alternatively, the registers 618 may be organized in any other arrangement, format, or structure, such as by being distributed throughout the core 602 to shorten access time. The second bus 622 may be implemented by at least one of an I2C bus, a SPI bus, a PCI bus, or a PCIe bus.

Each core 602 and/or, more generally, the microprocessor 600 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 600 is a semiconductor device fabricated to include many transistors interconnected to implement the structures described above in one or more integrated circuits (ICs) contained in one or more packages.

The microprocessor 600 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 600, in the same chip package as the microprocessor 600 and/or in one or more separate packages from the microprocessor 600.

FIG. 7 is a block diagram of another example implementation of the programmable circuitry 512 of FIG. 5. In this example, the programmable circuitry 512 is implemented by FPGA circuitry 700. For example, the FPGA circuitry 700 may be implemented by an FPGA. The FPGA circuitry 700 can be used, for example, to perform operations that could otherwise be performed by the example microprocessor 600 of FIG. 6 executing corresponding machine-readable instructions. However, once configured, the FPGA circuitry 700 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 600 of FIG. 6 described above (which is a general purpose device that may be programmed to execute some or all of the machine-readable instructions represented by the flowcharts of FIGS. 3 and 4 but whose interconnections and logic circuitry are fixed once fabricated), the FPGA circuitry 700 of the example of FIG. 7 includes interconnections and logic circuitry that may be configured, structured, programmed, and/or interconnected in different ways after fabrication to instantiate, for example, some or all of the operations/functions corresponding to the machine-readable instructions represented by the flowcharts of FIGS. 3 and 4. In particular, the FPGA circuitry 700 may be thought of as an array of logic gates, interconnections, and switches. The switches can be programmed to change how the logic gates are interconnected by the interconnections, effectively forming one or more dedicated logic circuits (unless and until the FPGA circuitry 700 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3 and 4. As such, the FPGA circuitry 700 may be configured and/or structured to effectively instantiate some or all of the operations/functions corresponding to the machine-readable instructions of the flowchart(s) of FIGS. 3 and 4 as dedicated logic circuits to perform the operations/functions corresponding to those software instructions in a dedicated manner analogous to an ASIC. Therefore, the FPGA circuitry 700 may perform the operations/functions corresponding to the some or all of the machine-readable instructions of FIGS. 3 and 4 faster than the general-purpose microprocessor can execute the same.

In the example of FIG. 7, the FPGA circuitry 700 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 700 of FIG. 7 may access and/or load the binary file to cause the FPGA circuitry 700 of FIG. 7 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 700 of FIG. 7 to cause configuration and/or structuring of the FPGA circuitry 700 of FIG. 7, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 700 of FIG. 7 may access and/or load the binary file to cause the FPGA circuitry 700 of FIG. 7 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 700 of FIG. 7 to cause configuration and/or structuring of the FPGA circuitry 700 of FIG. 7, or portion(s) thereof.

The FPGA circuitry 700 of FIG. 7, includes example input/output (I/O) circuitry 702 to obtain and/or output data to/from example configuration circuitry 704 and/or external hardware 706. For example, the configuration circuitry 704 may be implemented by interface circuitry that may obtain a binary file, which may be implemented by a bit stream, data, and/or machine-readable instructions, to configure the FPGA circuitry 700, or portion(s) thereof. In some such examples, the configuration circuitry 704 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 706 may be implemented by external hardware circuitry. For example, the external hardware 706 may be implemented by the microprocessor 600 of FIG. 6.

The FPGA circuitry 700 also includes an array of example logic gate circuitry 708, a plurality of example configurable interconnections 710, and example storage circuitry 712. The logic gate circuitry 708 and the configurable interconnections 710 are configurable to instantiate one or more operations/functions that may correspond to at least some of the machine-readable instructions of FIGS. 3 and 4 and/or other desired operations. The logic gate circuitry 708 shown in FIG. 7 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 708 to enable configuration of the electrical structures and/or the logic gates to form circuits to perform desired operations/functions. The logic gate circuitry 708 may include other electrical structures such as look-up tables (LUTs), registers (e.g., flip-flops or latches), multiplexers, etc.

The configurable interconnections 710 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 708 to program desired logic circuits.

The storage circuitry 712 of the illustrated example is structured to store result(s) of the one or more of the operations performed by corresponding logic gates. The storage circuitry 712 may be implemented by registers or the like. In the illustrated example, the storage circuitry 712 is distributed amongst the logic gate circuitry 708 to facilitate access and increase execution speed.

The example FPGA circuitry 700 of FIG. 7 also includes example dedicated operations circuitry 714. In this example, the dedicated operations circuitry 714 includes special purpose circuitry 716 that may be invoked to implement commonly used functions to avoid the need to program those functions in the field. Examples of such special purpose circuitry 716 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 700 may also include example general purpose programmable circuitry 718 such as an example CPU 720 and/or an example DSP 722. Other general purpose programmable circuitry 718 may additionally or alternatively be present such as a GPU, an XPU, etc., that can be programmed to perform other operations.

Although FIGS. 6 and 7 illustrate two example implementations of the programmable circuitry 512 of FIG. 5, many other approaches are contemplated. For example, FPGA circuitry may include an on-board CPU, such as one or more of the example CPU 720 of FIG. 6. Therefore, the programmable circuitry 512 of FIG. 5 may additionally be implemented by combining at least the example microprocessor 600 of FIG. 6 and the example FPGA circuitry 700 of FIG. 7. In some such hybrid examples, one or more cores 602 of FIG. 6 may execute a first portion of the machine-readable instructions represented by the flowchart(s) of FIGS. 3 and 4 to perform first operation(s)/function(s), the FPGA circuitry 700 of FIG. 7 may be configured and/or structured to perform second operation(s)/function(s) corresponding to a second portion of the machine-readable instructions represented by the flowcharts of FIGS. 3 and 4, and/or an ASIC may be configured and/or structured to perform third operation(s)/function(s) corresponding to a third portion of the machine-readable instructions represented by the flowcharts of FIGS. 3 and 4.

It should be understood that some or all of the circuitry of FIG. 2 may, thus, be instantiated at the same or different times. For example, same and/or different portion(s) of the microprocessor 600 of FIG. 6 may be programmed to execute portion(s) of machine-readable instructions at the same and/or different times. In some examples, same and/or different portion(s) of the FPGA circuitry 700 of FIG. 7 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 600 of FIG. 6 may execute machine-readable instructions in one or more threads executing concurrently and/or in series. In some examples, the FPGA circuitry 700 of FIG. 7 may be configured and/or structured to carry out operations/functions concurrently and/or in series. Moreover, in some examples, some or all of the circuitry of FIG. 2 may be implemented within one or more virtual machines and/or containers executing on the microprocessor 600 of FIG. 6.

In some examples, the programmable circuitry 512 of FIG. 5 may be in one or more packages. For example, the microprocessor 600 of FIG. 6 and/or the FPGA circuitry 700 of FIG. 7 may be in one or more packages. In some examples, an XPU may be implemented by the programmable circuitry 512 of FIG. 5, which may be in one or more packages. For example, the XPU may include a CPU (e.g., the microprocessor 600 of FIG. 6, the CPU 720 of FIG. 7, etc.) in one package, a DSP (e.g., the DSP 722 of FIG. 7) in another package, a GPU in yet another package, and an FPGA (e.g., the FPGA circuitry 700 of FIG. 7) in still yet another package.

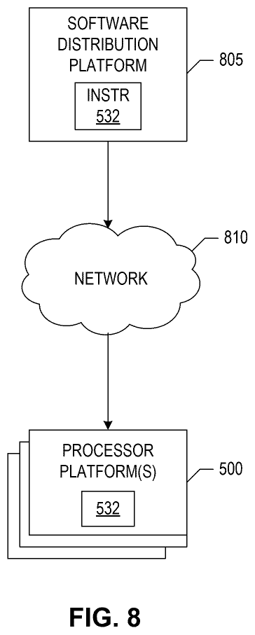

A block diagram illustrating an example software distribution platform 805 to distribute software such as the example machine-readable instructions 532 of FIG. 5 to other hardware devices (e.g., hardware devices owned and/or operated by third parties from the owner and/or operator of the software distribution platform) is illustrated in FIG. 8. The example software distribution platform 805 may be implemented by any computer server, data facility, cloud service, etc., capable of storing and transmitting software to other computing devices. The third parties may be customers of the entity owning and/or operating the software distribution platform 805. For example, the entity that owns and/or operates the software distribution platform 805 may be a developer, a seller, and/or a licensor of software such as the example machine-readable instructions 532 of FIG. 5. The third parties may be consumers, users, retailers, OEMs, etc., who purchase and/or license the software for use and/or re-sale and/or sub-licensing. In the illustrated example, the software distribution platform 805 includes one or more servers and one or more storage devices. The storage devices store the machine-readable instructions 532, which may correspond to the example machine-readable instructions of FIGS. 3 and 4, as described above. The one or more servers of the example software distribution platform 805 are in communication with an example network 810, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 532 from the software distribution platform 805. For example, the software, which may correspond to the example machine-readable instructions of FIGS. 3 and 4, may be downloaded to the example programmable circuitry platform 500, which is to execute the machine-readable instructions 532 to implement the apparatus 200. In some examples, one or more servers of the software distribution platform 805 periodically offer, transmit, and/or force updates to the software (e.g., the example machine-readable instructions 532 of FIG. 5) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed to monitor correctable errors for a device interface based on a cache-coherent, input/output, and memory access protocol. Disclosed systems, apparatus, articles of manufacture, and methods improve the efficiency of a computing device by signaling correctable errors at a particular error rate, so that a persistent error can be predicted, and system performance impacts can be mitigated. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to implement a correctable error counter and a leaky bucket for a device interface are disclosed herein. Further examples and combinations thereof include the following:

Example 1 includes an apparatus comprising interface circuitry, machine-readable instructions, and at least one out-of-band processor circuit to be coupled to at least one host processor circuit, the at least one out-of-band processor circuit to be programmed by the machine-readable instructions to at least detect a first error in a link between devices, increment an error count after the detection of the first error, decrement the error count after a duration has elapsed relative to the first error, and cause a message to be sent to a reliability, accessibility, and serviceability agent after the error count satisfies a threshold.

Example 2 includes any preceding clause(s) of example 1, wherein one or more of the at least one out-of-band processor circuit is to start a timer based on a timeout value, the timer to track the duration.

Example 3 includes any preceding clause(s) of any one or more of Examples 1-2, wherein one or more of the at least one out-of-band processor circuit is to allocate a software leaky bucket after the detection of the first error, the error count and the timer corresponding to the software leaky bucket.

Example 4 includes any preceding clause(s) of any one or more of Examples 1-3, wherein one or more of the at least one out-of-band processor circuit is to restart the timer after the error count is decremented.

Example 5 includes any preceding clause(s) of any one or more of Examples 1-4, wherein one or more of the at least one out-of-band processor circuit is to execute an error monitor process after the detection of the first error.

Example 6 includes any preceding clause(s) of any one or more of Examples 1-5, wherein the message is a machine check architecture message.

Example 7 includes any preceding clause(s) of any one or more of Examples 1-6, including the at least one host processor circuit to generate a first correctable machine check interrupt after the error count satisfies the threshold, the first correctable machine check interrupt to cause a basic input/output system to at least one of log an error event or create a second correctable machine check interrupt to notify an operating system of the error event.

Example 8 includes at least one non-transitory machine-readable medium comprising machine-readable instructions to cause programmable circuitry to at least detect a first correctable error in a link between devices, increment an error count after the detection of the first correctable error, decrement the error count after a duration has elapsed since the detection of the first correctable error, and cause sending of a message to an agent after the error count satisfies a threshold.

Example 9 includes any preceding clause(s) of example 8, wherein the machine-readable instructions are to cause the programmable circuitry to start a timer based on a threshold error notification rate, the timer to track the duration.

Example 10 includes any preceding clause(s) of any one or more of examples 8-9, wherein the machine-readable instructions are to cause the programmable circuitry to allocate a software leaky bucket after the detection of the first correctable error, the error count and the timer corresponding to the software leaky bucket.

Example 11 includes any preceding clause(s) of any one or more of examples 8-10, wherein the machine-readable instructions are to cause the programmable circuitry to restart the timer after the error count is decremented.

Example 12 includes any preceding clause(s) of any one or more of examples 8-11, wherein the machine-readable instructions are to cause the programmable circuitry to detect the first correctable error based on a machine check architecture message from a digital interconnect link agent.

Example 13 includes any preceding clause(s) of any one or more of examples 8-12, wherein the machine-readable instructions are to cause the programmable circuitry to, after the error count satisfies the threshold, decrease a speed of the link.

Example 14 includes any preceding clause(s) of any one or more of examples 8-14, wherein the machine-readable instructions are to cause the programmable circuitry to generate a first correctable machine check interrupt after the error count satisfies the threshold, the first correctable machine check interrupt to cause a basic input/output system to at least one of log an error event or create a second correctable machine check interrupt to notify an operating system of the error event.

Example 15 includes a method comprising detecting a first correctable error in a link between devices, incrementing, by programmable circuitry programmed by at least one instruction, an error count after the detection of the first correctable error, decrementing, by the programmable circuitry, the error count after a duration has elapsed since the detection of the first correctable error, and causing, by the programmable circuitry, sending of a message to an agent after the error count satisfies a threshold.

Example 16 includes any preceding clause(s) of example 15, including starting a timer to track the duration, the duration corresponding to a maximum error notification rate.

Example 17 includes any preceding clause(s) of any one or more of examples 15-16, including allocating a software leaky bucket after the detecting of the first correctable error, the error count and the timer corresponding to the software leaky bucket.

Example 18 includes any preceding clause(s) of any one or more of examples 15-17, including restarting the timer after the error count is decremented.

Example 19 includes any preceding clause(s) of any one or more of examples 15-18, wherein the detecting of the first correctable error is based on a machine check architecture message from a digital interconnect link agent.

Example 20 includes any preceding clause(s) of any one or more of examples 15-19, including decreasing a speed of the link after the error count satisfies the threshold.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
at least one out-of-band processor circuit to be coupled to at least one host processor circuit, the at least one out-of-band processor circuit to be programmed by the machine-readable instructions to at least:
detect a first error in a link between devices;
increment an error count after the detection of the first error;
decrement the error count after a duration has elapsed relative to the first error; and
cause a message to be sent to a reliability, accessibility, and
serviceability agent after the error count satisfies a threshold.

2. The apparatus of claim 1, wherein one or more of the at least one out-of-band processor circuit is to start a timer based on a timeout value, the timer to track the duration.

3. The apparatus of claim 2, wherein one or more of the at least one out-of-band processor circuit is to allocate a software leaky bucket after the detection of the first error, the error count and the timer corresponding to the software leaky bucket.

4. The apparatus of claim 2, wherein one or more of the at least one out-of-band processor circuit is to restart the timer after the error count is decremented.

5. The apparatus of claim 1, wherein one or more of the at least one out-of-band processor circuit is to execute an error monitor process after the detection of the first error.

6. The apparatus of claim 1, wherein the message is a machine check architecture message.

7. The apparatus of claim 1, including the at least one host processor circuit to generate a first correctable machine check interrupt after the error count satisfies the threshold, the first correctable machine check interrupt to cause a basic input/output system to at least one of log an error event or create a second correctable machine check interrupt to notify an operating system of the error event.

8. At least one non-transitory machine-readable medium comprising machine-readable instructions to cause programmable circuitry to at least:
detect a first correctable error in a link between devices;
increment an error count after the detection of the first correctable error;
decrement the error count after a duration has elapsed since the detection of the first correctable error; and
cause sending of a message to an agent after the error count satisfies a threshold.

9. The at least one non-transitory machine-readable medium of claim 8, wherein the machine-readable instructions are to cause the programmable circuitry to start a timer based on a threshold error notification rate, the timer to track the duration.

10. The at least one non-transitory machine-readable medium of claim 9, wherein the machine-readable instructions are to cause the programmable circuitry to allocate a software leaky bucket after the detection of the first correctable error, the error count and the timer corresponding to the software leaky bucket.

11. The at least one non-transitory machine-readable medium of claim 9, wherein the machine-readable instructions are to cause the programmable circuitry to restart the timer after the error count is decremented.

12. The at least one non-transitory machine-readable medium of claim 8, wherein the machine-readable instructions are to cause the programmable circuitry to detect the first correctable error based on a machine check architecture message from a digital interconnect link agent.

13. The at least one non-transitory machine-readable medium of claim 8, wherein the machine-readable instructions are to cause the programmable circuitry to, after the error count satisfies the threshold, decrease a speed of the link.

14. The at least one non-transitory machine-readable medium of claim 8, wherein the machine-readable instructions are to cause the programmable circuitry to generate a first correctable machine check interrupt after the error count satisfies the threshold, the first correctable machine check interrupt to cause a basic input/output system to at least one of log an error event or create a second correctable machine check interrupt to notify an operating system of the error event.

15. A method comprising:
detecting a first correctable error in a link between devices;
incrementing, by programmable circuitry programmed by at least one instruction, an error count after the detection of the first correctable error;
decrementing, by the programmable circuitry, the error count after a duration has elapsed since the detection of the first correctable error; and
causing, by the programmable circuitry, sending of a message to an agent after the error count satisfies a threshold.

16. The method of claim 15, including starting a timer to track the duration, the duration corresponding to a maximum error notification rate.

17. The method of claim 16, including allocating a software leaky bucket after the detecting of the first correctable error, the error count and the timer corresponding to the software leaky bucket.

18. The method of claim 16, including restarting the timer after the error count is decremented.

19. The method of claim 15, wherein the detecting of the first correctable error is based on a machine check architecture message from a digital interconnect link agent.

20. The method of claim 15, including decreasing a speed of the link after the error count satisfies the threshold.
